(19) United States
(12) Patent Application Publication
(10) Pub. No.: US 2015/0163351 A1
(43) Pub. Date: Jun. 11, 2015

(54) PROJECTED CALL DURATION VALUES BASED ON AMBIENT CONDITIONS

(71) Applicant: International Business Machines Corporation, Armonk, NY (US)

(72) Inventors: Gary D. Cudak, Creedmoor, NC (US); Lydia M. Do, Raleigh, NC (US); Christopher J. Hardee, Raleigh, NC (US); Adam Roberts, Moncure, NC (US)

(73) Assignee: International Business Machines Corporation, Armonk, NY (US)

(21) Appl. No.: 14/102,543

(22) Filed: Dec. 11, 2013

(51) Int. Cl. H04M 3/42; H04W 4/16

(52) U.S. Cl. CPC H04M 3/42042; H04W 4/16

(57) ABSTRACT

A computer program product includes computer readable program code for detecting one or more ambient conditions using one or more components of a first communication device, computer readable program code for determining a projected call duration value for the first communication device as a function of the one or more detected ambient conditions, and computer readable program code for providing the projected call duration value to a second communication device prior to the second communication device connecting a call between the first and second communication devices. The second communication will preferably display the projected call duration value to the user to assist the user in deciding whether to initiate a call with the first communication device.

### BACKGROUND

1. Field of the Invention

The present invention relates to communication devices and systems, such as telephones and communication networks.

2. Background of the Related Art

Communication devices, such as telephones, are an integral part of everyday life in a modern society. Telephones that are connected to a land line are even on the decline, as people become accustomed to having a mobile phone with them at all times. The functions and features available on a mobile phone continues to expand, including apps, browsers, a camera, full physical or virtual keypads, touchscreens, wifi and Bluetooth connectivity, texting and email, and more.

When a first communication device is used to place a call to a second communication device, a telephone number or other identification associated with the second communication is entered using a keypad or voice command of the first communication device, or is identified from a list of contacts stored within the first communication device. Once the caller has initiated a call with the first communication device, the second communication device will typically produce an audible ring tone or vibrate in order to notify a called party (“recipient”) of the call. However, due to the wide range of tasks that a user may perform on their telephone, the variety of social contexts that a user may be involved in due to increasing mobility and usability of telephones, and the resulting increase in the amount of time that a user spends on their telephone, it is increasingly common that a call will not be answered promptly or, if answered, that the purpose of the call cannot be satisfied.

While voicemail is helpful for dealing with missed calls, a voice message is inherently a one-way communication from the calling party to the called party. Accordingly, voicemail frequently does not satisfy the calling party's need to talk with the called party. For example, in an urgent situation, a calling party may need to obtain information or assistance from the called party. Conversely, if the calling party wants to have an extended interactive discussion with the called party, voicemail does not provide the interaction with the called party that may be needed to efficiently achieve the purpose of the call. Since the called party is typically unaware of the purpose of the calling party's call, it is frequently the result that a first phone call between the two parties will only result in a plan to have a second phone call at a later point in time.

### BRIEF SUMMARY

One embodiment of the present invention provides a computer program product including computer readable program code embodied on a computer readable storage medium. The computer program product comprises computer readable program code for detecting one or more ambient conditions using one or more components of a first communication device, computer readable program code for determining a projected call duration value for the first communication device as a function of the one or more detected ambient conditions, and computer readable program code for providing the projected call duration value to a second communication device prior to connecting a call between the first and second communication devices.

Another embodiment of the present invention provides a computer program product including computer readable program code embodied on a computer readable storage medium. The computer program product comprises computer readable program code for storing historical call duration data of a first communication device, wherein the historical call duration data includes a plurality of records, each record including a call duration value and one or more conditions of the first communication device that are associated with the call duration value. The computer program product further comprises computer readable program code for identifying a current condition of the first communication device, computer readable program code for determining a projected call duration value for the first communication device based on call duration values in the stored historical call duration data having a condition matching the current condition of the first communication device, and computer readable program code for providing the projected call duration value to a second communication device prior to connecting a call between the first and second communication devices.

### BRIEF DESCRIPTION OF THE SEVERAL VIEWS OF THE DRAWINGS

FIG. 1 is a block diagram of the components of a communication device in accordance with one embodiment of the invention.

FIG. 2 is a diagram of a system including a communication network enabling communication between a plurality of communication devices.

FIG. 3 is a diagram of an exemplary compute node (or simply “computer”) that may be utilized as the network management device consistent with some embodiments of the present invention.

FIG. 4 is a diagram of a display screen of the communication device displaying setup options for implementing projected call duration features.

FIG. 5 is a diagram of the communication device having a display screen displaying a phone contacts list.

FIG. 6 is a flowchart of a method in accordance with one embodiment of the present invention.

FIG. 7 is a flowchart of a method according to another embodiment of the present invention.

### DETAILED DESCRIPTION

One embodiment of the present invention provides a method comprising detecting one or more ambient conditions using one or more components of a first communication device, determining a projected call duration value for the first communication device as a function of the one or more detected ambient conditions, and providing the projected call duration value to a second communication device prior to connecting a call between the first and second communication devices.

The second communication device preferably displays the projected call duration value received from the first communication device along with an identifier of the first communication device. Accordingly, a user of the second communication device has access to the projected call duration value when deciding whether or not to initiate a call to the first communication. For example, the projected call duration value for the first communication device may be displayed along with a Contacts list stored in the second communication device. Furthermore, the Contacts list may display a projected call duration value for any or all of the contacts listed in the Contacts list, such that the user is able to view the projected call duration values when browsing through the Contacts list. Optionally, the projected call duration values may be collected and displayed only in a Favorites list, which is a subset of all contacts.

The first communication device may include one or more components or sensors that are capable of detecting one or more ambient conditions in the environmental around the first communication device. Non-limiting examples of the one or more components or sensors may include a camera, microphone, global positioning system receiver, accelerometer, wireless receiver, other detectors or sensors, or combinations thereof. The ambient conditions are detectable conditions surrounding the current location of the first communication device. For example, when the one or more components includes a camera, the camera may detect one or more ambient conditions selected from an identity of a person whose image is captured by the camera, a number of people in an image captured by the camera, and combinations thereof. When the one or more components includes a microphone, the microphone may detect one or more ambient conditions selected from an identity of a person whose voice is detected by the microphone, a number of people whose voices are detected by the microphone, and combinations thereof. Optionally, the first communication device includes a voice recognition module for determining the identity of the person whose voice is detected by the microphone. When the one or more components includes a global positioning system receiver, the one or more ambient conditions may include a location of the first communication device detected by the global positioning system receiver. When the one or more components includes an accelerometer, the one or more ambient conditions may include a pattern of physical movement of the first communication device detected by the accelerometer. For example, a regular repeating pattern of similar up and down movements may indicate that a user is running, whereas irregularly spaced movements of irregular magnitude may indicate the user is doing housework. When the one or more components includes a wireless receiver, the one or more ambient conditions may be selected from a proximity of other communication devices detected by the wireless receiver, an identity of a person whose communication device is detected by the wireless receiver, and combinations thereof. Furthermore, the status of other proximate communication devices may be considered, perhaps by increasing the projected call duration value in response to detecting that the only communication device that is proximate to the first communication device is currently handling a call. This might be determined by either detecting the wireless signal or by the microphone detecting one side of a conversation.

Embodiments of the present invention determine a projected call duration value for the first communication device as a function of the one or more ambient conditions. In one example, determining a projected call duration value includes identifying a projected call duration value that has been stored in association with the one or more ambient conditions. Accordingly, a memory may store a list or table of records that store projected call duration values in association with one or more ambient conditions that existed at the time that each call occurred, such as at the point in time that the call was initiated. Furthermore, the projected call duration value associated with a selected one of the ambient conditions may be a predetermined call duration value that was manually entered by a user and stored by the first communication device. Manually entered call duration values may be entered through a graphical user interface, such as a Setup menu in the operating system of the first communication device.

In a further embodiment, determining a projected call duration value for the first communication device may include automatically calculating the projected call duration value as a function of historical call duration data collected under the selected ambient condition. For example, if the first communication device has a microphone and a voice recognition module, the first communication device may detect that the user is having a conversation with her boss. This presumes that the first communication device has a stored contact for the boss that includes a voice signature and a title or relationship status that identifies the person as the user's boss. The first communication device may then search historical call duration data to identify previous incoming calls that occurred under the same conditions, i.e., that occurred while the user was having a conversation with her boss. Some measure of those calls may be used as the projected call duration value. For example, the projected call duration value may be the average of all incoming calls that occurred while the user was having a conversation with her boss. Since most people would be reluctant to interrupt a conversation with their boss to answer a call, the average call duration under this detected ambient condition is expected to be low. Accordingly, this call duration value is provided to a user of the second communication device such that the user has this information available when deciding whether or not to call the first communication device.

The specific manner in which a projected call duration value is determined may vary widely and is not limited to the examples provided. However, some additional examples are provided to further illustrate the breadth of the present invention. In one option, the projected call duration value may scale, perhaps using an algebraic function, with the number of people (voices, images or communication devices) detected in proximity of the first communication device. In another option, the projected call duration value may scale, perhaps using an algebraic function, with the participation level (of the user of the first communication device) in the in-person conversation. In other words, voice recognition may determine whether the intended recipient of a call is actively involved in a face to face conversation or not participating in the conversation at all. The projected call duration value may also be changed in response to determining that the first communication device is located in confined area, such as car or elevator, where other people are detected. If it is detected that others in proximity to the first communication device have accepted calls in the current environment, then the projected call duration may be increased. In a further option, the projected call duration may be a function of the identity of the caller based on historical call duration data showing the caller and the called party have a history of long conversations. Still further, historical call duration data for the first communication device may indicate that the user has longer calls in the late afternoon than in the morning, and this may be reflected by increasing the projected call duration values in the later afternoon.

The function of determining a projected call duration value for the first communication device as a function of the one or more detected ambient conditions may be performed by the first communication device or by a network server providing this service. In the latter option, it is possible to perform the voice recognition on the network server and/or store the historical call duration data in memory accessible to the network server. Performing these function on the network server will reduce the workload and memory requirements of the first communication device.

Projected call duration values have been described above as being provided in units of time, such as minutes. However, the projected call duration values may be expressed in other manners as may be useful, such as an amount of time per hour or amount of time per day (i.e., units of time per unit of time). Expressing a projected call duration value in units of time per unit of time allows the projected call duration value to be a function of recent call time. For example, if a user typically spends five minutes on calls during each hour of the day, but has already spend four minutes on a call this hour then the original projected call duration value of five minutes per hour would be reduced to provide a current projected call duration value of one minute per hour.

Another embodiment of the present invention provides a method that includes storing historical call duration data of a first communication device, wherein the historical call duration data includes a plurality of records, each record including a call duration value and one or more conditions of the first communication device that are associated with the call duration value. The method further includes identifying a current condition of the first communication device, determining a projected call duration value for the first communication device based on call duration values in the stored historical call duration data having a condition matching the current condition of the first communication device, and providing the projected call duration value to a second communication device prior to connecting a call between the first and second communication devices.

While the one or more current conditions in this embodiment may be any of the ambient conditions previously described, the one or more current conditions of the first communication device may also be a time of day or an application status, such as a calendar entry indicating that the user of the first communication device is scheduled to be in a quarterly conference call. In a specific example, the current condition may be a time of day, and the projected call duration value may be determined based on the records of the historical call duration data that are associated with the time of day, such as a typical lunchtime. In a further example, the current condition of the first communication device may be traveling on a route to a destination entered into a map application, and the projected call duration value may be determined based on the records of the historical call duration data that are associated with an estimated time to reach the destination. Accordingly, a projected call duration value may reflect that a user may typically accept calls during driving and may have long conversations while driving, but is less likely to answer or talk long during the last few minutes before reaching a destination or in heavy traffic conditions. Alternatively, the projected call duration value may reflect the nature of the destination, such that the projected call duration value may be decreased near arrival at a movie theater destination since call are not allowed in a move theater or increased near arrival at home on the assumption that the user will have free time.

In a still further embodiment, the first communication device may be instructed, perhaps through its user setting a user preference option, to further provide a preferred time of day for receiving calls, provide a time of day when the user has more time for long calls, or provide a time of day when the user prefers to receive calls from the particular caller. This may also be displayed in a Contacts list of a caller's communication device, such that if the projected call duration value is not present sufficient for the caller's purpose then the caller can see a time of day when the recipient typically has time for a longer call.

Yet another embodiment of the present invention provides a computer program product including computer readable program code embodied on a computer readable storage medium. The computer program product comprises computer readable program code for detecting one or more ambient conditions using one or more components of a first communication device, computer readable program code for determining a projected call duration value for the first communication device as a function of the one or more detected ambient conditions, and computer readable program code for providing the projected call duration value to a second communication device prior to connecting a call between the first and second communication devices.

An additional embodiment of the present invention provides a computer program product including computer readable program code embodied on a computer readable storage medium. The computer program product comprises computer readable program code for storing historical call duration data of a first communication device, wherein the historical call duration data includes a plurality of records, each record including a call duration value and one or more conditions of the first communication device that are associated with the call duration value. The computer program product further comprises computer readable program code for identifying a current condition of the first communication device, computer readable program code for determining a projected call duration value for the first communication device based on call duration values in the stored historical call duration data having a condition matching the current condition of the first communication device, and computer readable program code for providing the projected call duration value to a second communication device prior to connecting a call between the first and second communication devices.

The foregoing computer program products may further include computer readable program code for implementing or initiating any one or more aspects or steps of the methods described herein. Accordingly, a separate description of the methods will not be duplicated in the context of a computer program product.

It should be recognized that any of the embodiments of the method or computer program product may cover both a first situation where the first communication device initiates a call to the second communication device and a second situation where the second communication device initiates a call to the first communication device. In other words, the projected call duration values of a recipient communication device may be provided to the calling communication device prior to connecting a call there between, the projected call duration values of the calling communication device may be provided to the recipient communication device prior to connecting a call there between, or both the recipient and calling communication devices may provide their projected call duration values to the other of the communication devices prior to connecting a call there between. Accordingly, either of the caller or recipient, or both the caller and the recipient, (via their respective communication devices) may have the benefit of the other's project call duration values before the call is connected. It should be further recognized that either of the caller or recipient, or both the caller and the recipient, (via their respective communication devices) may use the components and sensors of the communication devices to collect data regarding ambient conditions for use in determining a projected call duration value in accordance with various embodiments of the present invention.

### Example

Gary is having lunch with Adam and both Gary and Adam have their own communication devices (“phones”) with them. Gary's phone has a wireless receiver that detects Adam's phone with a quick response time indicating it is very proximate. Gary's phone may also include a GPS receiver that detects the current location is a frequented restaurant and may include memory storing data evidencing that, historically, Gary doesn't hold long conversations on the phone at this time of day (lunch) or when at this location. Gary's phone may use the detected conditions that Gary is with Adam at a restaurant during lunch time and use these conditions as search criteria into the historical call duration data to identify or calculate a projected call duration value of 30 seconds. Chris may pull up his Contacts list with the intention of calling Gary about a complicated matter, but upon seeing his own phone display a projected call duration value to Gary of only 30 seconds, Chris decides that it would be better to try to call Gary later.

The present invention may be applied to other forms of communication, such as the video calls.

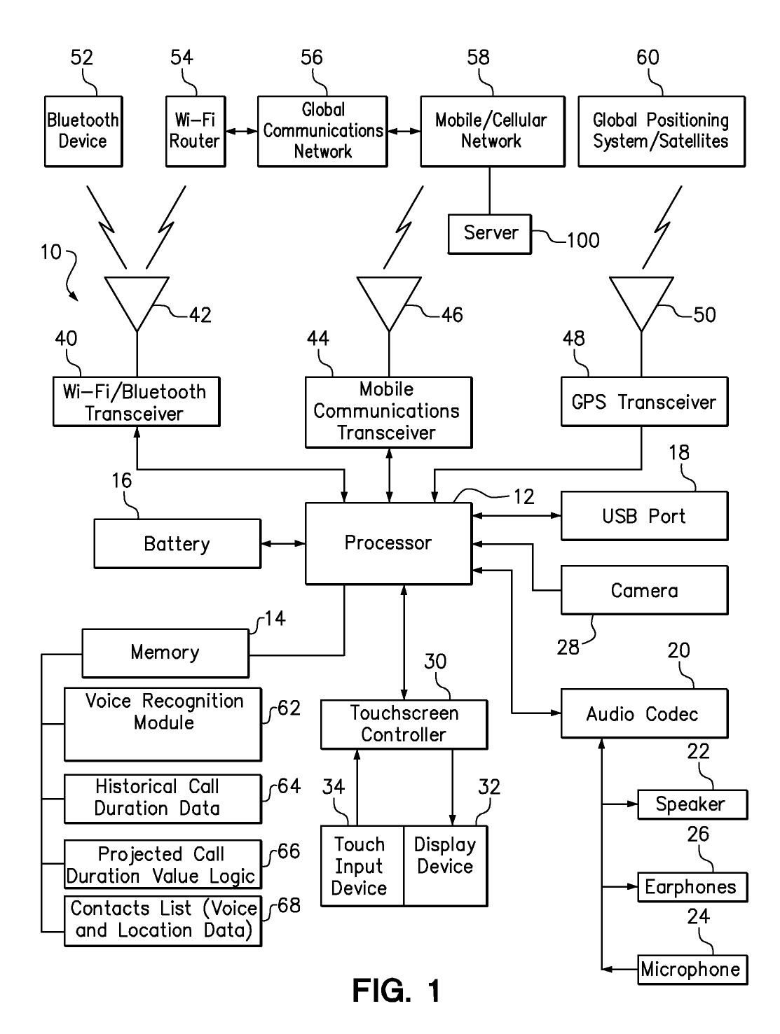

FIG. 1 is a block diagram of the components of a communication device 10, such as a smart phone, capable of implementing embodiments of the present invention. The block diagram may be representative of both a first communication device and a second communication device in accordance with various embodiments of the present invention. The communication device 10 may include a processor 12, memory 14, a battery 16, a universal serial bus (USB) port 18, a camera 28, and an audio codec 20 coupled to a speaker 22, a microphone 24, and an earphone jack 26. The communication device 10 may further include a touchscreen controller 30 which provides a graphical output to the display device 32 and an input from a touch input device 34. Collectively, the display device 32 and touch input device 34 may be referred to as a touchscreen.

The communication device 10 may also include a Wi-Fi and/or Bluetooth transceiver 40 and corresponding antenna 42 allowing the device to communicate with a Bluetooth device 52 or a Wi-Fi router 54, a mobile communication transceiver 44 and corresponding antenna 46 allowing the device to communicate over a mobile/cellular network 58, and a global positioning system (GPS) transceiver 48 and corresponding antenna 50 allowing the device to obtain signals from a global positioning system or satellites 60. In a non-limiting example, the Wi-Fi router 54 and the mobile/cellular network 58 may be connected to a global communications network 56, such as the Internet. Furthermore, mobile/cellular network 58 may include or access a server for the purpose of storing call duration data or a voice recognition module for the communication device 10. When the communication device 10 has memory 14 with sufficient capacity, it is preferably to include any or all of these data storage and logic functions within the communication device itself. As shown, the memory 14 stores a voice recognition module 62, historical call duration data 64, projected call duration value logic 66, and a Contacts list 68 with optional voice data and location data associated with one or more of the contacts in the list.

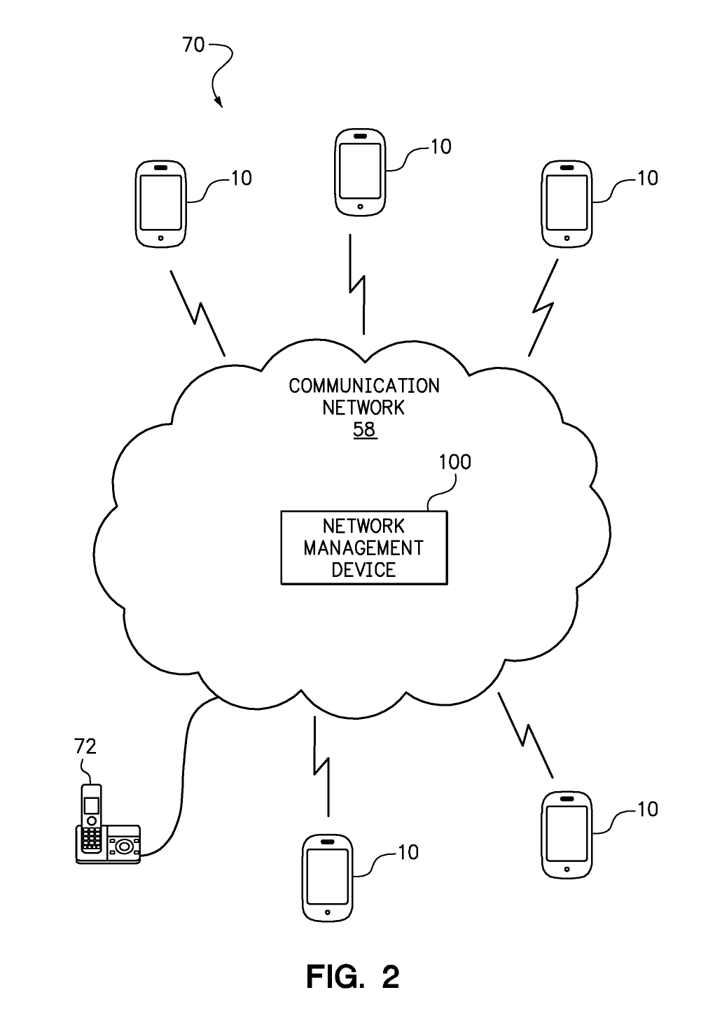

FIG. 2 is a diagram of a system 70 including a communication network 58 enabling communication between a plurality of communication devices, such as a telephone 72 coupled to a land line and multiple mobile telephones 10. The communication network 58 may be managed by a network management device 100. The network management device 100 may be responsible for establishing connections between communications devices, and may also provide one or more services to the communications devices. For example, although the methods of the invention may be implemented within one of the communication devices 30, 60, it is also possible to implement one or more steps of the methods or one or more functions of the computer program code of the present invention in the network management device 100. In one non-limiting example, the network management device 100 may run a voice recognition module 62 and store historical call duration data 64.

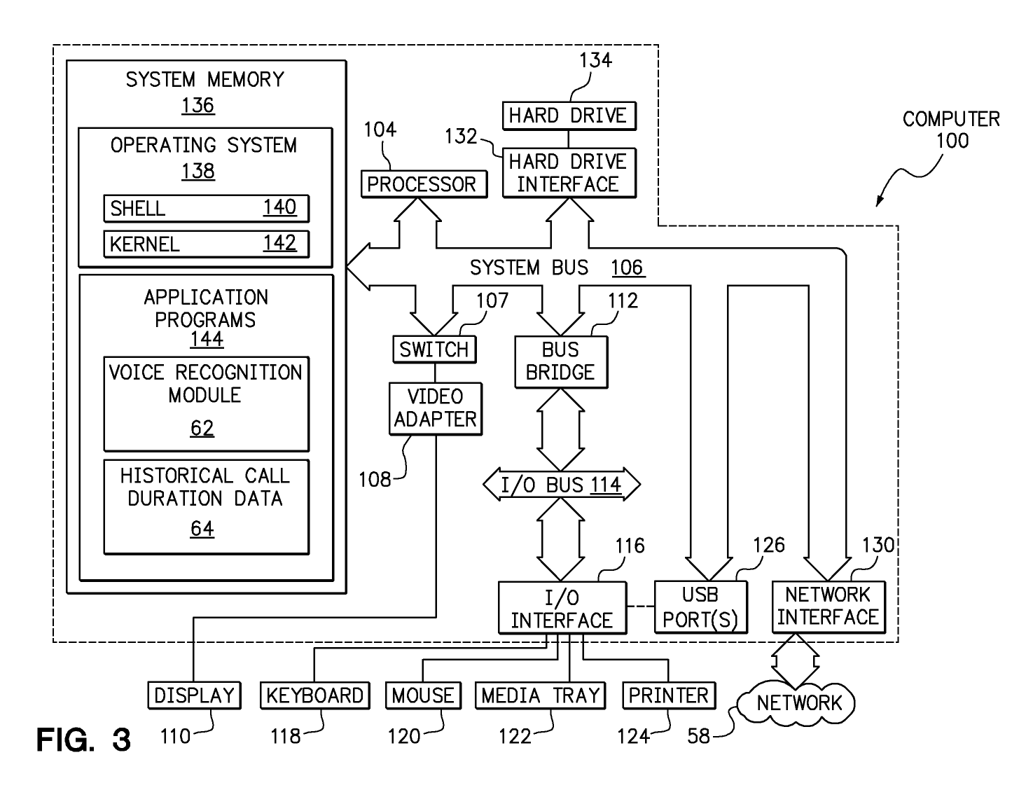

FIG. 3 is a diagram of an exemplary compute node or server (or simply “computer”) 100 that may be utilized as the network management device consistent with embodiments of the present invention. Note that some or all of the exemplary architecture, including both depicted hardware and software, shown for and within computer 100 may be implemented in the server or network management device 100 as shown in FIGS. 1-2.

The computer 100 includes a processor unit 104 that is coupled to a system bus 106. Processor unit 104 may utilize one or more processors, each of which has one or more processor cores. A video adapter 108, which drives/supports a display 110, is also coupled to system bus 106. In one embodiment, a switch 107 couples the video adapter 108 to the system bus 106. Alternatively, the switch 107 may couple the video adapter 108 to the display 110. In either embodiment, the switch 107 is a switch, preferably mechanical, that allows the display 110 to be coupled to the system bus 106, and thus to be functional only upon execution of instructions that support the processes described herein.

The system bus 106 is coupled via a bus bridge 112 to an input/output (I/O) bus 114. An I/O interface 116 is coupled to I/O bus 114. I/O interface 116 affords communication with various I/O devices, including a keyboard 118, a mouse 120, a media tray 122 (which may include storage devices such as CD-ROM drives, multi-media interfaces, etc.), a printer 124, and (if a VHDL chip 137 is not utilized in a manner described below), external USB port(s) 126. While the format of the ports connected to I/O interface 116 may be any known to those skilled in the art of computer architecture, in a preferred embodiment some or all of these ports are universal serial bus (USB) ports.

As depicted, the computer 100 is able to communicate over a network 58 using a network interface 130. The network 58 may be an external network such as the cellular network or global communication network 56, and perhaps also an internal network such as an Ethernet or a virtual private network (VPN).

A hard drive interface 132 is also coupled to system bus 106. Hard drive interface 132 interfaces with a hard drive 134. In a preferred embodiment, hard drive 134 populates a system memory 136, which is also coupled to system bus 106. System memory is defined as a lowest level of volatile memory in computer 100. This volatile memory includes additional higher levels of volatile memory (not shown), including, but not limited to, cache memory, registers and buffers. Data that populates system memory 136 includes computer 100's operating system (OS) 138 and application programs 144.

The operating system 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management. Application programs 144 in the system memory of computer 100 may include various programs and modules for implementing the methods described herein, such as the voice recognition module 62 and the historical call duration data 64.

The hardware elements depicted in computer 100 are not intended to be exhaustive, but rather are representative components suitable to perform the processes of the present invention. For instance, computer 100 may include alternate memory storage devices such as magnetic cassettes, digital versatile disks (DVDs), Bernoulli cartridges, and the like. These and other variations are intended to be within the spirit and scope of the present invention.

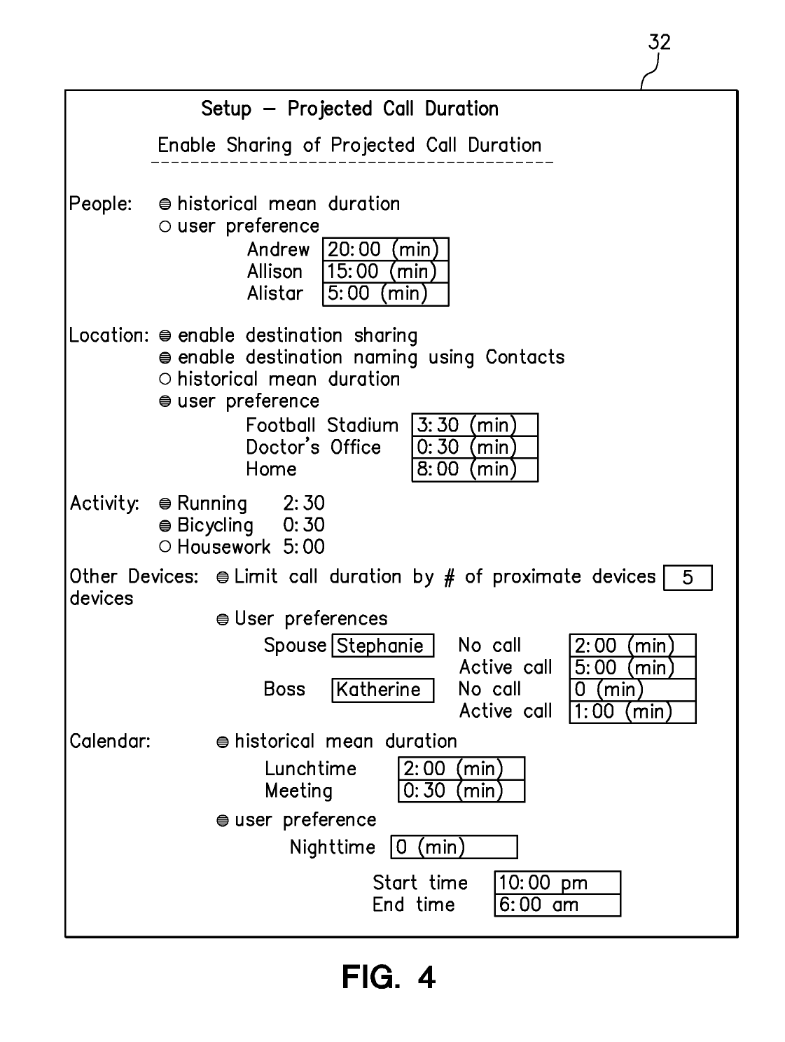

FIG. 4 is a diagram of a display screen 32 of the communication device displaying setup options for implementing projected call duration features. In a “People” section, the user has instructed the communication device to use “historical mean duration” of calls with particular people, such that the historical mean call duration with Andrew is 20 minutes, with Allison is 15 minutes, and with Alistair is 5 minutes. Accordingly, these call duration values may be used as the projected call duration value, unless some other factor indicates that the value should be less. In a “Location” section of the Setup screen, the user has enabled destination sharing such that callers (authorized potential callers, such as in the user's Favorites list) may be informed of the amount of time until the user reaches a destination. Also, the user has enabled destination naming using Contacts, such that the caller may receive the name of the destination. The user has then enabled and entered user preferences as to the desired call duration at various locations, such as 3:30 minutes at a football stadium, 0:30 minutes at a doctor's office, and 8:00 minutes at home.

In the “Activities” section, the projected call duration while running is 2:30 minutes and while bicycling is 30 seconds. These activities may be determined by an accelerometer, as previously discussed. In the “Other Devices” section, the user wants to reduce call duration when in the proximate area of 5 or more devices. Also, the user has entered preferences so that when the user is with his spouse Stephanie, the projected call duration value should be 2:00 minutes if Stephanie is not on a call, but 5:00 is Stephanie is actively on a call. Similarly, the user preferences will provide a projected call duration value of 0 minutes when the user is in a conversation with his boss Katherine and Katherine is not on a call, but 1 minute when the user is with Katherine while she is on a call.

Finally, the “Calendar” section indicates that the user intends to provide projected call duration values using historical mean durations, which are 2:00 minutes at lunchtime and 30 seconds during a meeting. However, the user has set a user preference to provide a projected call duration value of zero (a preference for no calls) at nighttime, which has been entered as the time between 10:00 pm and 6:00 am.

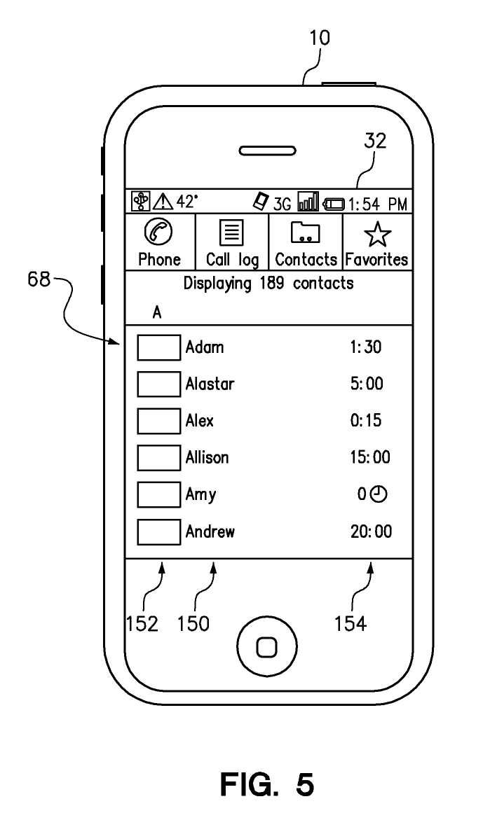

FIG. 5 is a diagram of the communication device 10 having a display screen 32 displaying a portion of a phone contacts list 68. Each contact is identified by a name 150, an optional icon or picture 152, and a projected call duration value 154 received from the communication devices of the respective contact. Optionally, the project call duration value 154 may be displayed only for contacts that are on a “Favorites” list.

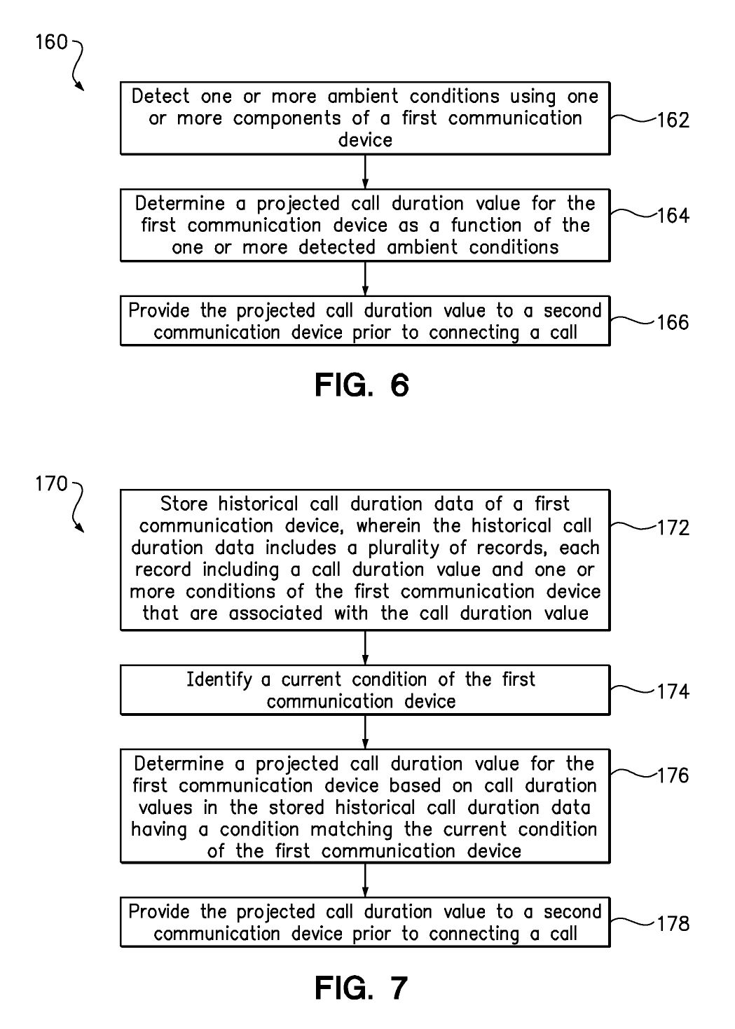

FIG. 6 is a flowchart of a method 160 according to one embodiment of the present invention. In step 162, the method detects one or more ambient conditions using one or more components of a first communication device. In step 164, the method determines a projected call duration value for the first communication device as a function of the one or more detected ambient conditions. Then, in step 166, the projected call duration value is provided to a second communication device prior to connecting a call between the first and second communication devices.

FIG. 7 is a flowchart of a method 170 according to another embodiment of the present invention. In step 172, the method includes storing historical call duration data of a first communication device, wherein the historical call duration data includes a plurality of records, and wherein each record includes a call duration value and one or more conditions of the first communication device that are associated with the call duration value. A current condition of the first communication device is identified in step 174, before step 176 determines a projected call duration value for the first communication device based on call duration values in the stored historical call duration data having a condition matching the current condition of the first communication device. The projected call duration value is then provided to a second communication device prior to connecting a call between the first and second communication devices, as shown in step 178.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer program product including computer readable program code embodied on a computer readable storage medium, the computer program product including:
computer readable program code for detecting one or more ambient conditions using one or more components of a first communication device;
computer readable program code for determining a projected call duration value for the first communication device as a function of the one or more detected ambient conditions; and
computer readable program code for providing the projected call duration value to a second communication device prior to connecting a call between the first and second communication devices.

2. The computer program product of claim 1, wherein the second communication device displays the projected call duration value received from the first communication device along with an identifier of the first communication device.

3. The computer program product of claim 1, wherein computer readable program code for determining a projected call duration value for the first communication device as a function of the one or more ambient conditions, includes computer readable program code for identifying a projected call duration value stored in association with the one or more ambient conditions.

4. The computer program product of claim 3, wherein the projected call duration value associated with a selected one of the ambient conditions is a predetermined call duration value manually entered and stored by the first communication device.

5. The computer program product of claim 1, wherein computer readable program code for determining a projected call duration value for the first communication device as a function of the one or more ambient conditions, includes computer readable program code for automatically calculating the projected call duration value as a function of historical call duration data collected under the selected ambient condition.

6. The computer program product of claim 1, further comprising:
computer readable program code for displaying the projected call duration value along with an identification of the first communication in a contacts list of the second communication device.

7. The computer program product of claim 1, wherein the one or more components includes a camera and the one or more ambient conditions are selected from an identity of a person whose image is captured by the camera, a number of people in an image captured by the camera, and combinations thereof.

8. The computer program product of claim 1, wherein the one or more components includes a microphone and the one or more ambient conditions are selected from an identity of a person whose voice is detected by the microphone, a number of people whose voices are detected by the microphone, and combinations thereof, the computer program product further comprising:
computer readable program code for using voice recognition to determine the identity of the person whose voice is detected by the microphone.

9. The computer program product of claim 1, wherein the first communication device initiates the call to the second communication device.

10. The computer program product of claim 1, wherein the one or more components includes a global positioning system receiver and the one or more ambient conditions includes a location of the first communication device detected by the global positioning system receiver.

11. The computer program product of claim 1, wherein the one or more components includes an accelerometer and the one or more ambient conditions includes a pattern of physical movement of the first communication device detected by the accelerometer.

12. The computer program product of claim 1, wherein the one or more components includes a wireless receiver and the one or more ambient conditions is selected from a proximity of other communication devices detected by the wireless receiver, an identity of a person whose communication device is detected by the wireless receiver, and combinations thereof.

13. The computer program product of claim 1, wherein the computer readable program code for determining a projected call duration value for the first communication device as a function of the one or more detected ambient conditions is run by the first communication device or a network server.

14. The computer program product of claim 1, wherein the second communication device initiates the call to the first communication device.

15. A computer program product including computer readable program code embodied on a computer readable storage medium, the computer program product comprising:
computer readable program code for storing historical call duration data of a first communication device, wherein the historical call duration data includes a plurality of records, each record including a call duration value and one or more conditions of the first communication device that are associated with the call duration value;
computer readable program code for identifying a current condition of the first communication device;
computer readable program code for determining a projected call duration value for the first communication device based on call duration values in the stored historical call duration data having a condition matching the current condition of the first communication device; and
computer readable program code for providing the projected call duration value to a second communication device prior to connecting a call between the first and second communication devices.

16. The computer program product of claim 15, wherein the current condition of the first communication device is a time of day, and wherein the projected call duration value is based on the records of the historical call duration data that are associated with the time of day.

17. The computer program product of claim 15, wherein the current condition of the first communication device is traveling on a route to a destination entered into a map application, and wherein the projected call duration value is based on the records of the historical call duration data that are associated with an estimated time to reach the destination.

18. The computer program product of claim 15, wherein the computer readable program code for determining a projected call duration value for the first communication device is run by the first communication device or a network server.

19. The computer program product of claim 15, wherein the first communication device initiates the call to the second communication device.

20. The computer program product of claim 15, wherein the second communication device initiates the call to the first communication device.
